(19) United States
(12) Patent Application Publication
(10) Pub. No.: US 2008/0131561 A1
(43) Pub. Date: Jun. 5, 2008

(54) Formulation of supplemented carrageenan jelly and manufacturing process

(75) Inventor: Surach Patanawongyuneyong, Samutprakarn (TH)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(73) Assignee: Sahachol Food Supplies Co., Ltd., Sriracha (TH)

(21) Appl. No.: 11/904,516

(22) Filed: Sep. 26, 2007

(30) Foreign Application Priority Data
Dec. 1, 2006 (TH) 0603001889
Jun. 14, 2007 (TH) 0703000642
Aug. 2, 2007 (TH) 0703000830

(51) Int. Cl. A23L 1/30

(52) U.S. Cl. 426/72

(57) ABSTRACT

A supplemented carrageenan jelly comprising water, carrageenan, vegetable or fruit juice, and nutrient supplements, with the balance being a combination of a sweetener, a preservative, flavorings, and an acid.

### BACKGROUND

The human body requires nutrients to build and maintain healthy bodily functions. The human body acquires essential nutrients through the consumption of variety of foods. Poor health can be caused by an imbalance of nutrients, either an excess or deficiency, which, in turn, affects bodily functions cumulatively.

Since human nutrition is complex, a healthy diet may vary widely, subject to an individual's genetic make up, environment, and health. For many people, obtaining an optimum nutrition entirely through the consumption of food stuffs is impractical. For example, an individual may find that obtaining a particular nutrient from specific foods is expensive, impractical, or unpalatable.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is flow chart showing an exemplary method of processing dietary supplemented carrageenan jelly, according to principles described herein.

Throughout the drawings, identical reference numbers designate similar, but not necessarily identical, elements.

### DETAILED DESCRIPTION

Dietary supplements are intended to supply nutrients, such as vitamins, minerals, fatty acids, or amino acids that are missing or not consumed in sufficient quantities in a person's diet. Dietary supplements may also contain herbs and other substances meant to improve human health. The supplements may come as pills, capsules, powders, or liquids.

The desirability of dietary supplements, like other foods, is based on the personal preference of the individual. Factors that may be considered by the individual consuming a dietary supplement may include texture, taste, color, convenience, price, perceived efficacy, packaging, etc. These factors consciously and subconsciously contribute to the total experience of the individual as they consume the dietary supplement.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

For many people, consuming dietary supplements in pill or capsule form is a less satisfying experience. The present invention discloses a supplemented carrageenan jelly that contains nutrients and natural juices in a carrageenan matrix. The combination of nutrients and natural juices enhances the total experience of consuming the dietary supplement. These juices can provide natural sweetness and/or flavor to the carrageenan jelly. In some cases the blend of nutrients and natural juices may have a synergistic effect on the health of the individual. For example, a natural juice may enhance the ability of the body to absorb and utilize the supplemental nutrients contained within the carrageenan jelly matrix.

Carrageenan may be utilized to make a gel containing supplement that is pleasing in taste and texture as well as being convenient to consume. Carrageenans are a family of linear sulfated polysaccharides extracted from seaweeds. The carrageenan molecules are relatively complex carbohydrate polymers made up of many monosaccharides joined together by glycosidic linkages. These large, highly flexible molecules form curled or helical structures. This gives them the ability to form a variety of different gels at room temperature. The gel prevents the movement of molecules and particles within the three dimensional network of carrageenan. This network traps and contains fluid, forming a gel, or in lower concentrations, creates thickened or structured liquid. One particular advantage of carrageenans is that they are thixotropic—they thin under shear stress and recover their viscosity once the stress is removed. This means that they are easy to pump but stiffen again afterwards.

There are three main commercial classes of carrageenan: Kappa, Iota, and Lambda. Kappa carrageenan is derived Kappaphycus cottonii seaweed and produces strong, rigid gels. Iota carrageenan is derived Eucheuma spinosum seaweed and produces soft gels. Lamda carrageenan most commonly derived from the Gigartina seaweed from southern Europe. Lamda carrageenan is typically used to form a light gel in diary products. All types of carrageenan are soluble in hot water, but in cold water only Lamda carrageenan and the sodium salts of Kappa and Iota carrageenan are soluble.

Carrageenans are widely used in food and other industries to thicken, emulsify, stabilize, and change the texture of products. Carrageenan is used to increase viscosity and provide volume to desserts, ice cream, milk shakes, and sauces. Carrageenan is used as a stabilizer to prevent separation of constituent parts of the product and increases the shelf life of products that undergo repeated freeze-thaw cycles. Carrageenan is also added to liquids to enhance the visual clarity of the liquid.

Ordinarily, carrageenan comprises 2% or less of the total mass of the product. Carrageenan has a neutral taste, and rarely disrupts the flavor of food products that incorporate it.

By way of example and not limitation, the following nutrients may be incorporated into the supplemented carrageenan jelly.

Co-Q-10: Coenzyme Q-10 can be effective in protecting the skin and slowing the formation of wrinkles. Coenzyme Q-10 has also been shown to be effective in improving the function of heart muscles and in treating heart disease.

Omega-3: Omega-3 is an essential nutrient that cannot be synthesized by the human body. Therefore, Omega-3 or its precursors must be introduced into the human body from external sources. Omega-3 may promote neuronal growth which benefits those with brain damage or Alzheimer's disease. Omega-3 is also reported to have contributed to reducing the risk of heart disease and balancing cholesterol levels.

Collagen: Collagen a fibrous structural protein that is a major component of extracellular matrix that supports most tissues and gives cells structure. Healthy collagen promotes skin strength and elasticity, healthy joint tissues, as well as strong ligaments and tendons.

L-Arginine: Arginine is an α-amino acid. The L-form is one of the 20 most common natural amino acids. In mammals, arginine is classified as a semi-essential or conditionally essential amino acid, depending on the developmental stage and health status of the individual. It plays an important role in cell division, the healing of wounds, building muscle mass, removing ammonia from the body, immune functions, and the release of hormones. It has been shown to promote health of the cardiovascular system and, in combination with proanthocynidins, has been used as a treatment for erectile dysfunction.

L-Ornithine: L-Ornithine plays a part in the human hormone system, contributes to building muscle mass, and stimulates the immune system.

Isoflavones: Isoflavones act as a phytoestrogens (plant generated substances that act as estrogen in mammals and humans). The use of isoflavones can reduce symptoms of menopause, such as hot flashes and osteoporosis. Isoflavones are also strong antioxidants and are thought to be useful in treating cancer.

Lycopene: Lycopene is a bright red carotenoid phytochemical found in tomatoes and other red fruits. Lycopene is the most common carotenoid in the human body and is one of the most potent cartenoid antioxidants. Benefits of lycopene include some amelioration of cardiovascular disease, cancer, diabetes, osteoporosis, and even male infertility.

Vitamin A: Vitamin A is important to developing and maintaining vision and is important for proper bone growth. Vitamin A also helps to improve skin conditions such as acne psoriasis and guards against bacterial, viral, or parasitic infection.

Vitamin D: Vitamin D plays an important role in the maintenance of organ systems. It regulates the calcium and phosphorus levels in the blood by promoting their absorption from food. It promotes bone formation and mineralization. It is essential in the development of an intact and strong skeleton. Vitamin D also affects the parathyroid hormone secretion and the immune system, where it promotes phagocytosis and anti-tumor activity.

Vitamin E: Vitamin E is a potent antioxidant. Vitamin E is particularly important for the protection of cell membranes as well as keeping skin, circulatory system, nerves, muscles and blood cells healthy.

Vitamin K: Vitamin K plays an important role in blood clotting and formation of strong bones.

Vitamin C: Vitamin C is an essential nutrient for humans. Vitamin C is an antioxidant and helps protect the body against oxidative stress and is a cofactor in several vital enzyme reactions. It helps the white blood cells combat infection and is essential for wound healing, formation of collagen, as well as keeping immune system healthy.

Vitamin B1(Thiamin): Vitamin B1 is an important nutrient for a healthy nervous system and enhances memory, concentration, and digestion.

Vitamin B2 (Riboflavin): Vitamin B2 promotes healthy hair, skin, nails, and vision. It can also help prevent cataracts and decrease the frequency and intensity of migraine headaches.

Vitamin B3 (Niacin): Vitamin B3 assists in the regulation of energy within the body. It has an important role in metabolizing carbohydrates and is important in controlling the level of blood glucose. It may also ease arthritis symptoms.

Vitamin B5 (Pantothenic acid): Pantothenic acid is needed to form coenzyme-A (CoA), and is critical in the metabolism and synthesis of carbohydrates, proteins, and fats. It can promote growth, reduce allergies, and help to reduce depression and anxiety.

Vitamin B6 (Pyridoxine): Pyridoxine assists in the balancing of sodium and potassium as well as promoting red blood cell production. It is linked to cardiovascular health by decreasing the formation of homocysteine. In addition, pyridoxine can help balance hormonal changes in women and aid in immune system.

Vitamin B12 (Cobalamin): Vitamin B12 is important for the normal functioning of the brain and nervous system and for the formation of blood. It is involved in the metabolism of every cell in the body, especially affecting the DNA synthesis and regulation, but also participates in fatty acid synthesis and energy production.

Biotin: Biotin is important in the catalysis of essential metabolic reactions to synthesize fatty acids, in gluconeogenesis, and in metabolizing leucine.

Calcium: Calcium is essential for the normal growth and maintenance of bones and teeth. Calcium intake must continue throughout life. It is also important element in the transmission of nerve impulses and blood clotting.

Magnesium: Magnesium is required for processing adenosine triphosphate (ATP) and related reactions. It is an important nutrient for building bone, strong peristalsis, and may increase joint flexibility.

Iron: Iron is required for many proteins and enzymes, notably hemoglobin.

Copper: Copper is required component of many redox enzymes, including cytochrome C-oxidase.

Iodine: Iodine is required for the biosynthesis of thyroxin which could minimize effects of Down's syndrome and tyrotoxicosis.

Zinc: Zinc is important for general growth, the proper functioning of the prostate gland, and help to adjust the blood insulin levels.

Manganese: Manganese is a trace mineral required by all known living organisms and functions as cofactor for a number of enzymes.

Sodium: Sodium is an important electrolyte and plays a role in controlling homeostasis and the transport of nutrition from the blood solution to the surrounding cells.

Potassium: Potassium is also an important electrolyte and plays a role in the transmission of nerve impulses and in controlling homeostasis in the body.

Selenium: Selenium is an antioxidant.

Chromium: Chromium is an essential trace mineral that helps to control sugar metabolism and insulin response in humans.

Molybdenum: Molybdenum supports the body's utilization of iron, the nervous system, heart, and may help prevent sterility.

Fluoride: Fluoride, or fluorine compounds such as sodium fluoride, calcium fluoride, and sodium monofluorophosphate increase the resistance of tooth enamel to decay.

Phosphorus: Phosphorus is necessary for proper bone growth, tooth development, and production of enamel.

L-Threonine: L-Threonine assists in healthy blood circulation and digestion. In particular, L-Threonine may help to ease an upset stomach.

L-Phenylalanine: L-Phenylalanine helps in digestion and hormone synthesis.

L-Leucine: L-Leucine expedites lipolysis, or the break down of stored fats into usable energy.

L-Lysine: L-Lysine is essential for growth and the regulation of the human metabolism.

L-Valine: L-Valine supports the regulation of brain, muscles, and nervous system.

L-Isoleucine: L-Isoleucine is an essential nutrient that assists in the metabolism of fat into energy.

L-Glutamine: L-Glutamine regulates the activity of nerve cells and is useful in treating depression and anxiety.

L-Glutathione: L-Glutathione can inhibit excess melanin synthesis and prevents dark spots on the skin. L-Glutathione also has antioxidant properties.

L-Carnitine: L-Carnitine can delay degradation of cells within the human body, prevent heart disease, increase energy levels, and decrease stress.

L-Cystine: L-Cystine supports healthy hair growth, insulin synthesis, and builds up the immune system.

L-Cysteine: L-Cysteine can reduce the production of melanin pigment, resulting in a lighter skin tone with fewer blemishes.

Taurine: Taurine is a major constituent of digestive enzymes that break down fat and helps control fat absorption. Taurine may also promote good vision.

L-Tyrosine: L-Tyrosine delays cell maturity and controls satiety through its influence in the lateral hypothalamus area.

Green Tea Extract (Calthechin): Calthechin is an antioxidant which could reduce cholesterol absorption into the blood.

Grape Seed Extract (Proanthocynidin or Procyanidolic Oligomers: PCO): Grape seed extract is an antioxidant which supports the vascular system and reduces the incidence of beriberi, a nervous system ailment that is caused by thiamine (vitamin B₁) deficiency.

Lutein: Lutein can prevent damage of optical nerve cells and the eye by free radicals.

Bilberry Extract: Bilberry extract can support good vision and is used to treat various eye disorders.

Ginkgo Biloba Extract: Ginkgo Biloba extract promotes brain activity and enhances memory. It also supports the circulatory system.

White Kidney Bean Extract (Phaseolamin) Fermented Soybean Extract: Phaseolamin is a proteinaceous inhibitor of alpha-amylase and is used as a dieting aid. By inhibiting alpha-amylase, less sugar is absorbed in the small intestine.

Garcinia Extract (Hydroxycitric acid): Garcinia extract can inhibit lipogenesis (the formation of lipids/fats) from glucose.

Omega 6 Fatty Acid (Conjugated Linoleic Acid): Omega-6-fatty acid can inhibit adipose cell formation, increase energy metabolism from lipids, and inhibit protein degradation in skeletal muscles.

Garlic (Garlic Extract): Garlic is claimed to reduce cholesterol, high blood pressure, and vertigo; adjust blood glucose levels, assist in the secretion of wastes from the body, and to prevent eczema.

Lecithin: Lecithin can control cholesterol levels through its role in fat metabolisis, prevent calculus in gall-bladder, increase vitamin A, D, E, K absorption, prevents liver disease, and promotes a healthy nervous system.

Beta-carotene: Beta-carotene helps in improve night vision and protect the skin from ultraviolet solar radiation.

Alpha-carotene: Alpha-carotene can help prevent cardiovascular disease and to reduce the risk of certain cancers, such as lung and cervical cancer.

Cryptoxanthin: In the human body, cryptoxanthin is converted to vitamin A and is therefore considered a provitamin A. As with other carotenoids, cryptoxanthin is an antioxidant and may help prevent free radial damage to cells and DNA. It may be particularly useful in preventing cervical cancers.

Ginseng: Ginseng rhizomes are taken orally as adaptogens, aphrodisiacs, nourishing stimulants, and in the treatment of type II diabetes, and for sexual dysfunction in men.

Centella Extract: Centella extract helps promote good blood circulation, nourishes the brain cells, decreases stress and generally promotes the health of the nervous system.

Evening Primrose Oil: Evening Primrose oil is used to reduce the pains of premenstrual syndrome, increase the metabolism of lipids, and has astringent and sedative properties.

Marigold Extract: Marigold is antioxidant which can prevent eye damage.

Glucosamine: Glucosamine assists in cartilage synthesis and improves joint strength. It is a particularly effective treatment for osteoarthritis.

Spirulina: Spirulina is complete protein that has been found to prevent halitosis, reduces the severity of strokes, and improves recovery of movement after strokes. It shows promise in reversing age-related declines in memory and learning. It also has been used as an effective treatment of hay fever.

Hyaluronic Acid (HA): Hyaluronic acid can increase skin moisture and reduce wrinkles.

White Kwao Krua (Pueraria Mirifica): White Kwao Krua contains phytoestrogens (chemicals produced by plants that act like estrogens in mammals). White Kwao Krua can be used supplement the action of the body's own hormones, particularly estrogen. White Kwao Krua may have a role in the regulation of cholesterol, maintaining firm breasts, and the maintaining of proper bone density of post-menopausal women.

Red Kwao Krua (Butea Superba): Red Kwao Krua can be used as a phytoestrogen in hormone replacement therapy, particularly in andropause.

Chitosan: Chitosan can chelate free fatty acids and waste in blood.

Ginger or Ginger Extract: Ginger or ginger extract aids in digestion, reduces blood pressure, aids in the elimination of liquid wastes from the body through sweat, and reduces cholesterol levels.

Konjac or Glucomannan: Konjac or Glucomannan are soluble fibers that are used as a treatment for constipation, obesity, high cholesterol, acne vulgaris and type 2 diabetes.

These nutrients may be used singly or in combination with other nutrients to obtain the desired combination.

To improve the flavor and beneficial effects of the carrageenan jelly, juice or a combination of juices may be added. As used in the present specification and in the appended claims, the term “juice” refers to a liquid which contains vegetable or fruit derivatives. The term vegetable or fruit derivative encompasses vegetable or fruit tissues, intracellular fluids, extracts, concentrates, tinctures, and the like.

By way of example and not limitation, juices that can be added including apple juice, grape juice, lychee juice, peach juice, longan juice, orange juice, pineapple juice, mulberry juice, pomegranate juice, salak juice, carrot juice, green tea juice, watermelon juice, bale fruit juice, coffee, Rozelle juice, Jasmine tea juice, guava juice, tomato juice, mango juice, sugar cane juice, coconut juice, lemon grass juice, cantaloupe juice, rambutan juice, lemon juice, strawberry juice, passion fruit juice, tamarind juice, hairy basil juice, Chrysanthemum juice, safflower juice, cocoa juice, Chinese-vegetable jelly juice, pandanus juice, Indian pennywort leaf juice, winter melon juice, pear juice, cranberry juice, grapefruit juice, plum juice, nectarine juice, kiwi juice, cherry juice, lime juice, strawberry juice, mandarin orange juice, beet root juice and other edible juices. The juices may be used singly or in combination with other juices to obtain the desired flavor and other characteristics.

The sweetness of the mixture can be adjusted by adding sugar (sucrose), fructose syrup or a sweetener such as sorbitol, aspartame, sucralose, xylitol, and acesulfame-K. Sweetener can be added individually or in combination with other sweeteners. Acid (such as citric acid or malic acid) can also be added to adjust the tartness of the jelly. Furthermore, fruit or vegetable flavoring can be added to obtain desired flavor. Finally, preservation such as a sorbate or benzoate compound may be added to prolong shelf-life.

In one exemplary embodiment the dietary supplemented carrageenan jelly is comprised of water, carrageenan, sweeteners, nutritional additives, acid, flavor enhancing juices, flavors, and preservatives in the following proportions given in Table 1 below.

TABLE 1

| Ingredient | Percent (%) by Weight |
|---|---|
| Water | 94.982-48.00 |
| Carrageenan | 0.001-2.00 |
| Sugar (sucrose) or fructose or other sweeteners such as | 0.005-12.00 |
| sorbitol, aspartame, sucralose, xylitol, acesulfame-K, | |
| adding individually or mixture of more than one sweetener. | |
| Vegetable juices or fruits juices can be either one or | 5.00-30.00 |
| mixture of the following Juices; apple juice, grape juice, | |
| Lychee juice, peach juice, Longan juice, orange juice, | |
| Pineapple juice, mulberry juice, pomegranate juice, Salak | |
| juice, carrot juice, green tea juice, watermelon juice, bale | |
| fruit juice, coffee, Rozelle juice, Jasmine tea, guava juice, | |
| tomato juice, mango juice, sugar-cane juice, coconut juice, | |
| lemon grass juice, cantaloupe juice, rambutan juice, lemon | |
| juice, strawberry juice, passion fruit juice, tamarind juice, | |
| hairy basil juice, chrysanthemum juice, safflower juice, | |
| Cocoa, Chinese-vegetable jelly juice, pandanus juice, | |
| Indian pennywort leave juice, winter melon juice, pear | |
| juice, cranberry juice, grapefruit juice, plum juice, nectarine | |
| juice, kiwi juice, cherry juice, lime juice, strawberry juice, | |
| mandarin orange juice, beetroot juice. | |
| Acid to adjust the sour taste (citric acid or malic acid) | 0.01-0.80 |
| Supplements (Coenzyme Q10, Omega-3, Collagen, L- | 0.001-5.00 |
| arginine, L-ornithine, Isoflavone, Lycopene, Vitamin A, | |
| Vitamin D, Vitamin E, Vitamin K, Vitamin C, Vitamin B1, | |
| Vitamin B2, Niacin, Pantothenic Acid, Vitamin B6, Vitamin | |
| B12, Folate, Biotin, Calcium, Magnesium, Iron, Copper, | |
| Iodine, Zinc, Manganese, Sodium, Potassium, Selenium, | |
| Chromium, Molybdenum, Fluoride, Phosphorus, L- | |
| threonine, L-phynyalanine, L-methionine, L-leucine, L- | |
| lysine, L-valine, L-isoleucine, L-glutathione, L-glutathione, | |
| L-carnitine, L-crytine, L-Cysteine, Taurine, L-tryosine, | |
| Green Tea Extract (Calthechin), Grape Seed Extract, | |
| Bilberry Extract, Ginkgo Extract, Navy Bean Extract | |
| (Phaseolamin), Fermented Soybean Extract, Garcenia | |
| Cambogia Extract (Hydroxycitric Acid), Omega-6 Oil | |
| (Conjugated Linoleic Acid), Garlic (Garlic Extract), | |
| Lecithin, Beta Carotene, Alpha Carotene, Tryptoxanthin, | |
| Ginseng, Gotu Kola Extract, Eveningprimrose Oil, | |
| Marigold Extract, Glucosamine, Spirulina, Hyaluronic Acid | |
| (HA), White Kwao Krua (Pueraria Mirifica), Red Kwao | |
| Krua (Butea Superba), Chitosan, Ginger and Ginger | |
| Extract, Konjac or Glucomannan | |
| Flavor of selected fruit juice (vegetable) | 0.001-2.00 |
| Preservatives (sorbate or benzoate compounds) | 0-0.20 |

### Manufacturing Process

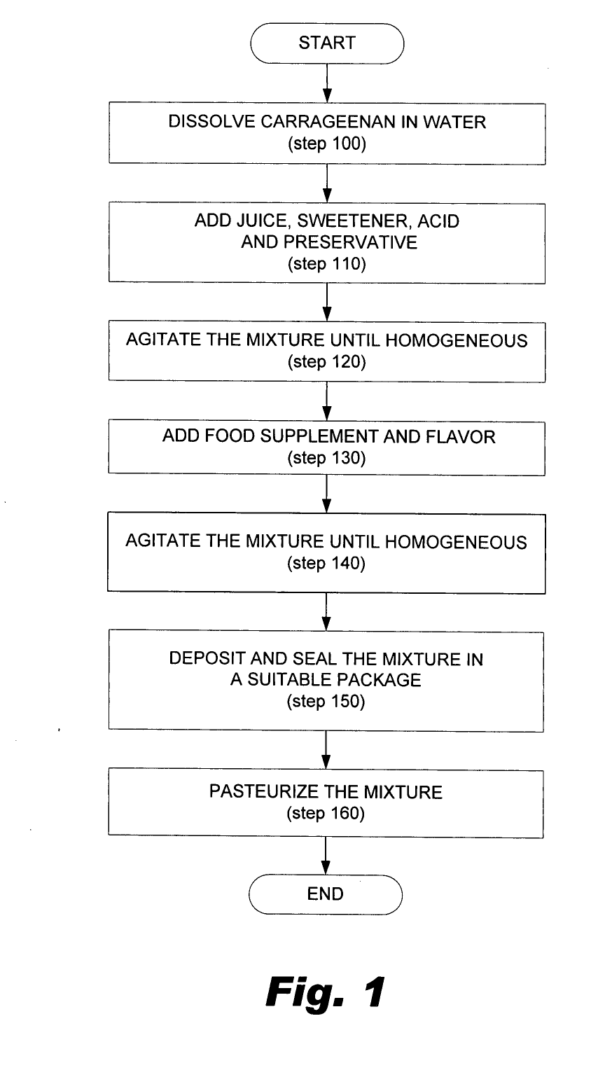

FIG. 1 shows one exemplary embodiment of a manufacturing process for making dietary supplemented carrageenan jelly. The first step is to dissolve the carrageenan in water (step 100). As mentioned above, all types of carrageenan are soluble in hot water, but in cold water only Lamda carrageenan and the sodium salts of Kappa and Iota carrageenan are soluble. The water should be an appropriate temperature to dissolve the type of carrageenan used.

After the carrageenan is dissolved, the temperature of the mixture can be adjusted. The juice, sweetener, acid, and preservative may then be added (step 110). In one embodiment the sweetener, acid, and preservative are optional ingredients. For example, if the juice contains a high concentration of natural sweeteners, such as grape juice, additional sweetener may not be required to achieve the desired flavor. Similarly, acid may or may not be required in a specific formulation of the carrageenan jelly. If the jelly is to be served immediately following its preparation or if the other ingredients perform a preservative function, the addition of a preservative may not be required.

Following the combination of ingredients in step 100 and step 110, the mixture is agitated until all of the ingredients are dissolved and the solution is homogeneous (step 120).

The food supplement and flavor can then be added to the mixture (step 130). The mixture is then agitated again until the mixture is homogeneous (step 140).

The mixture is then deposited and sealed in a suitable package (step 150). A variety of factors can be evaluated to determine what kind of package is suitable to contain the dietary supplemented carrageenan jelly, including sealing; protection from biological agents, light, and chemical degradation; functionality of the packaging for both the manufacturer and consumer; environmental issues, and packaging safety. By way of example and not limitation, the dietary supplemented carrageenan jelly could be packaged in aluminized Mylar bags or in a plastic boat with a thermosealed film affixed to the top of the boat to seal the container.

The pasteurization of the mixture (160) is performed with the jelly in its package form. Pasteurization is the process of heating products (typically liquids) for the purpose of destroying harmful organisms such as bacteria, viruses, protozoa, molds, and yeasts that may be contained within the product or packaging. Pasteurization is accomplished by bringing the product to a high temperature for a given amount of time. By way of example and not limitation, the dietary supplemented carrageenan jelly and its packaging could be soaked in a water bath at 85° C. for 30 minutes.

Subsequent operations, such as cooling the product in cold water, drying the container by evaporation or wiping, and packing the products into cartons can be performed following the pasteurization process.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A dietary supplement comprising:
water comprising 94.982% to 48.00% by weight;
carrageenan comprising 0.001% to 2.00% by weight;
vegetable or fruit juice comprising 5.00 to 30.00% by weight;
nutrient supplements comprising 0.001% to 5.00% by weight;
with the balance being comprised a combination of a sweetener, a preservative, flavorings, and an acid.

2. The dietary supplement of claim 1, wherein said sweetener comprises 0.005% to 12.00% by weight.

3. The dietary supplement of claim 2, wherein said sweetener is sucrose, fructose, sorbitol, aspartame, sucralose, xylitol, acesulfame-K or a mixture thereof.

4. The dietary supplement of claim 1, wherein said flavor comprises 0.001% to 2.00% by weight.

5. The dietary supplement of claim 1, wherein said acid comprises 0.01% to 0.80% by weight.

6. The dietary supplement of claim 5, wherein said acid is citric acid or malic acid or a combination thereof.

7. The dietary supplement of claim 1, wherein said preservative comprises 0.00% to 0.20% by weight.

8. The dietary supplement of claim 7, wherein said preservative comprises one or more of potassium sorbate, sorbic acid, sodium benzoate, and benzoic acid.

9. The dietary supplement of claim 1, wherein said vegetable or fruit juice is a mixture of one or more of the following juices: apple juice, grape juice, lychee juice, peach juice, longan juice, orange juice, mulberry juice, pomegranate juice, sala juice, carrot juice, green tea juice, watermelon juice, bael fruit tree juice, coffee, roselle juice, Chinese tea, guava juice, tomato juice, mango juice, sugar cane juice, coconut juice, lemon grass juice, cantaloupe juice, rambotan juice, pineapple juice, lemon juice, strawberry juice, passion fruit juice, tamarind juice, hairy basil juice, chrysanthemum juice, safflower juice, cocoa, grass jelly juice, pandanus juice, pennywort leaf juice, white gourd juice, pear juice, cranberry juice, grapefruit juice, plum juice, nectarine juice, kiwi juice, cherry juice, lime juice, strawberry juice, mandarin orange juice, or beet root juice.

10. The dietary supplement of claim 1, wherein said nutrient supplement is one or more of the following nutrients: Coenzyme Q10, Omega 3, Collagen, L-arginine, L-ornithine, Isoflavone, Lycopene, Vitamin A, Vitamin D, Vitamin E, Vitamin K, Vitamin C, Vitamin B1, Vitamin B2, Niacin, Pantothenic acid, Vitamin B6, Vitamin B12, Folate, Biotin, Calcium, Magnesium, Iron, Copper, Iodine, Zinc, Manganese, Sodium, Potassium, Selenium, Chromium, Molybdenum, Fluoride, phosphorous, L-threonine, L-Phynylalanine, L-methyonine, L-Luecine, L-lysine, L-valine, L-isoleucine, L-glutamine, L-glutamine, L-carnitine, L-cystine, L-cysteine, Taurine, L-tyrosine, Green tea extract (Calthechin), Grape seed extract, Lutein, Bilberry extract, Ginkgo Biloba extract, Navy bean extract (Phaseolamin), Fermented soy bean extract, Garcinia cambogia extract (Hyroxycitic acid), Omega 6 (Conjugated Linoleic Acid), Garlic (garlic extract), Lecithin, Betacarotene, Alphacarotene, Crytosanthin, Ginseng, Gotu Kola extract, Evening primrose oil, Marigold extract, Glucosamine, Spirulina, Hyaluronic acid (HA), White Kwao Krua (Pueraria Mirifica), Red Kwao Krua (Butea Superba), Chitosan, Ginger (Ginger extract), Konjac or Glucomannan

11. A method of manufacturing a dietary supplemented carrageenan jelly comprising:
dissolving carrageenan in water;
adding sweetener, juice, acid, and preservative;
agitating until all components are dissolved and the mixture is homogeneous;
adding nutrient supplement and flavor;
agitating until said mixture is homogeneous;
placing said mixture in a package that preserves the nutritive value of the gel;
sealing the package; and
pasteurizing the mixture and package by soaking in hot water.
